(19) United States
(12) Patent Application Publication
(10) Pub. No.: US 2009/0271726 A1
(43) Pub. Date: Oct. 29, 2009

(54) Providing Convenient Entry Points for Users in the Management of Field Devices

(75) Inventors: Santosh Gavimath, Bangalore (IN); Deepak Bhandiwad, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NE (US)

(21) Appl. No.: 12/109,343

(22) Filed: Apr. 25, 2008

(51) Int. Cl. G06F 3/048

(52) U.S. Cl. 715/771

(57) ABSTRACT

An aspect of the present invention enables administrators to specify custom entry points, which facilitate a user to access desired information quickly. In an embodiment, such administrator specified entry points are also displayed in a home page, which is displayed when a user requests management of a corresponding field device. The administrator may specify the specific information and form (e.g., graph, chart, field/value combination, etc.) to be displayed for each entry point, and the corresponding information is retrieved and displayed upon selection of the entry point.

### BACKGROUND OF THE INVENTION

1. Field of the Invention

The present invention generally relates to process control systems, and more specifically to providing convenient entry points for users in the management of field devices.

2. Related Art

A process control plant generally contains several field devices, which are operable to implement a desired control process (e.g., oil refinery, manufacturing operation, etc.). Field devices control local operations (typically in the plant floor controlling equipment such as boilers, furnaces, mixers, etc.) such as opening and closing valves and breakers, collecting data from sensor systems, and monitoring the local environment for alarm conditions.

Management of field devices refers to one or more of tasks such as setting up, configuring, utilizing and monitoring field devices. In a common scenario, a person (operator, administrator, etc.) uses a management station to perform various management tasks by using a suitable interface provided for that purpose. The interface is often controlled by software executing on the management station.

Entry points are often provided by management stations in the management of field devices. An entry point refers to the various navigation options made available to a user in any of various form such as menus, hyperlinks, buttons, etc., when the user selects (e.g., by clicking on a graphical user interface portion) a specific field device for management. The entry points are generally provided in the first page displayed to the person upon selection of the device using a management station.

Entry points generally make the related features easily accessible since the user may not need to navigate many screens to perform the related task (in case a control action is accessible via the entry point) or access the related information.

Entry points are often specified by field device manufacturers through a Device Description (DD) made available along with the field device. As is well known, a DD refers to a specification which indicates the manner (the specific content to send for a desired management task and what response to expect under various operating conditions, etc.) in which a corresponding field device (type) can be managed. Example specifications for DDs include, “IEC 61804-3 (2006-09):—Function blocks (FB) for process control—Part 3: Electronic Device Description Language (EDDL)” and ” IEC 61804-4:—Function blocks (FB) for process control—Part 4: EDD interoperability guideline” available from IEC Central Office, 3, rue de Varembé, P.O. Box 131, CH—1211 GENEVA, Switzerland

Such DD specified entry points may not be convenient enough in several environments. Several aspects of the present invention provide additional convenient entry points for users in the management of field devices.

### BRIEF DESCRIPTION OF THE DRAWINGS

The present invention will be described with reference to the accompanying drawings briefly described below.

FIG. 1 is a block diagram illustrating an example environment in which several aspects of the present invention can be implemented.

FIG. 2 is a flowchart illustrating the manner in which convenient entry points are provided for users, in the management of field devices, according to aspect of the present invention.

FIG. 3 is a flowchart illustrating the manner in which convenient entry points may be provided for users, in the management of field devices according to another aspect of the present invention.

FIGS. 4A-4H depict the manner in which convenient (custom) entry points may be specified by an administrator, in an embodiment of the present invention.

FIG. 5 is a block diagram of a digital processing system (server 160) which may enable a user to create custom entry points in an embodiment of the present invention.

FIG. 6 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

### 1. Overview

An aspect of the present invention enables administrators to specify custom entry points, which facilitate a user to access desired information quickly. In an embodiment, such administrator specified entry points are also displayed in a home page, which is displayed when a user requests management of a corresponding field device. The administrator may specify the specific information and form (e.g., graph, chart, field/value combination, etc.) to be displayed for each entry point, and the corresponding information is retrieved and displayed upon selection of the entry point.

Various aspects of the present invention facilitate providing convenient entry points for users in the management of field devices. Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

### 2. Example Environment

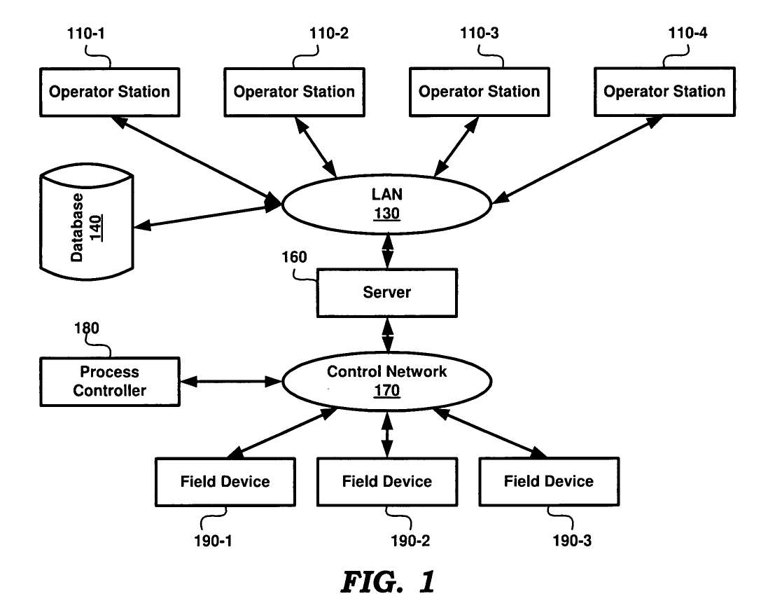

FIG. 1 is a block diagram illustrating an example environment in which several aspects of the present invention can be implemented. The environment is shown containing operator stations 110-1 to 110-4, LAN (Local Area Network) 130, database 140, server 160, control network 170, process controller 180, and field devices 190-1 to 190-3. Each block is described in further detail below.

The block diagram is shown containing only representative systems for illustration. However, real-world environments may contain more/fewer/different systems/components/blocks, both in number and type, depending on the purpose for which the environment is designed, as will be apparent to one skilled in the relevant arts. For example, though only three field devices are shown, there may be many more field devices in an environment.

Control network 170 connects server 160 and process controller 180 with field devices 190-1 to 190-3. Control network 170 may contain network devices (e.g., multiplexors, modems, termination panels, etc.,) operating according to one or more protocols such as HART, Control Net, Foundation Field Bus, etc. well known in the relevant arts.

LAN 130 provides communication between operator stations 120-1 to 120-4, database 140 and server 160 using protocols/technologies such as Ethernet, ATM, TCP/IP well known in the relevant arts.

Process controller 180 issues commands to control the operation of field devices 190-1 to 190-3 to implement a desired control strategy in the environment being controlled. In general, the desired control strategies can be programmed by (control) strategies pre-specified in database 140 (by server 160) based on inputs received from operator stations 110-1 to 110-4. Process controller 180 may receive various status information from the field devices, which are used in various decision points (e.g., if conditions) within a control strategy.

Database 140 provides a central repository for storing information related to field devices, maintenance schedules, etc. Generally, the stored information is retrieved and displayed (by a combination of server 160 and operation stations 110-1 to 110-4) to the user in the user interface provided in the client systems (for example operator stations 110-1 to 110-4).

Field devices 190-1 to 190-3 represent sensors (for process parameters for example, temperature, pressure, etc.), actuators (for example, valves, etc.), relays, etc., which perform various operations under the control of process controller 180. The field device manufacturer may provide a DD for each field device 190-1 to 190-3.

In an embodiment, the DD represents a (machine readable) file containing information relating to a field device such as parameter attributes (coding, name, engineering unit, how to display the parameter, etc.), the arrangement of the parameters in a menu structure, names of menus and submenus, information about operating interactions (device methods) for example calibration, information about visualization tools for example charts and graphs, etc. A DD may also contain entry points as described above. The DD may be stored in database 140 or provided from a removable storage device such as flash memory or made available through a manufacturer's web server which may be down loaded through a communication link (both not shown).

Server 160 receives commands from operator stations 110-1 to 110-4 related to setting up, configuring, utilizing, monitoring, etc., of field devices 190-1 to 190-3 and executes the corresponding actions. For example, utilizing a sensor (field device) may require server 160 to receive the parameters being measured by the field device using process controller 180 via control network 170, and return the information to the engineering station or operator station that issued the (status request) command. The data in database 140 may also be retrieved and returned to the application that issued a command, in response to corresponding command types.

Operator stations 110-1 to 110-4 provide the capability to manage various field devices, in addition to providing various other capabilities such as configuring various control strategies manually. In general, client systems provide a user interface using which users may manage field devices 190-1 to 190-3. The user interface entails displaying various screens, receiving user inputs (indicating the tasks to be performed), and providing responses again in the form of screens.

In an embodiment, each of the screens is provided by server 160 and the user at an operator station interacts with the screen for managing the field devices. As noted above, the DD may specify at least some of such management aspects, including the entry points available to a user.

As also noted above, the entry points may be specified within the DDs, implying that the entry points are specified by a device manufacturer. Various aspects of the present invention enable vendors of software (executing on server 160 and/or operator stations) and administrators with the capability to provide additional convenient entry points for the management of field devices.

It should be appreciated that vendors typically have responsibility for shipping software code, possibly along with various DDs, etc., in a manner that users can conveniently use the software thereafter. On the other hand, administrators have generally responsibility for additional configurations, etc., to the software/data, even after the software is installed and operational.

The manner in which such convenient entry points may be provided for users in the management of field devices in an embodiment of the present invention is described below in detail with examples.

### 3. Administrators Providing Convenient Entry Points

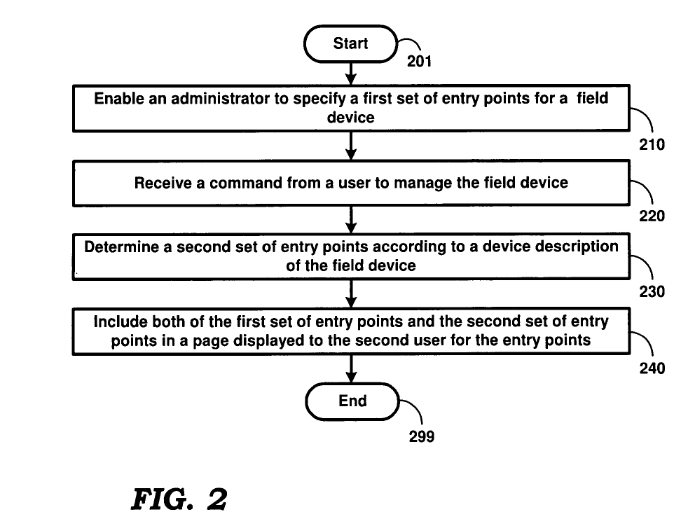

FIG. 2 is a flowchart illustrating the manner in which convenient entry points may be provided for users, in the management of field devices in an embodiment of the present invention. The flowchart is described with respect to FIG. 1, and in particular with reference to server 160, merely for illustration. However, various features can be implemented in other environments and other components/blocks without departing from several aspects of the present invention. Furthermore, the steps are described in a specific sequence merely for illustration.

Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 201, in which control passes immediately to step 210.

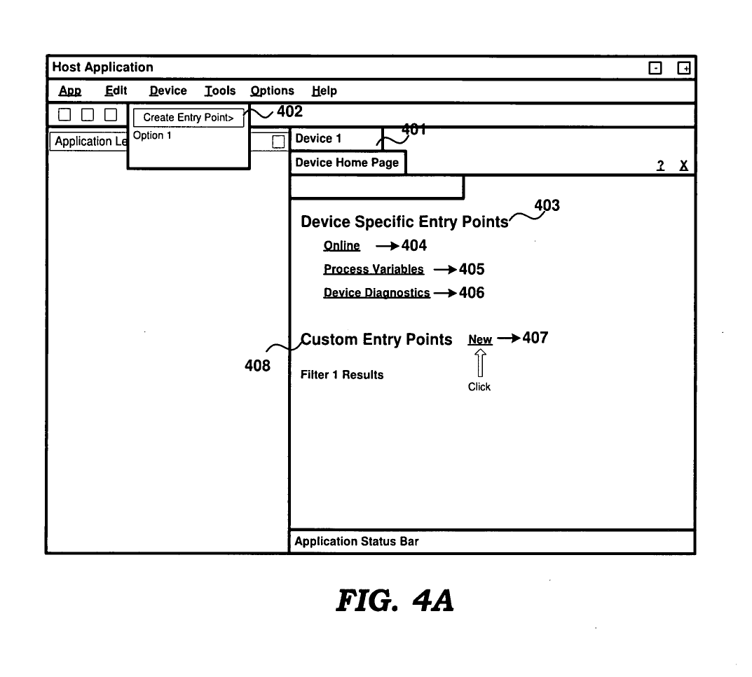

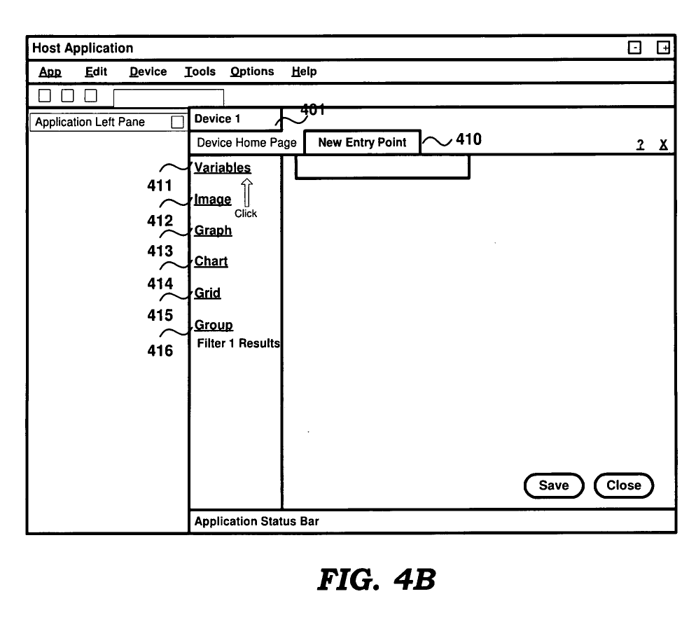

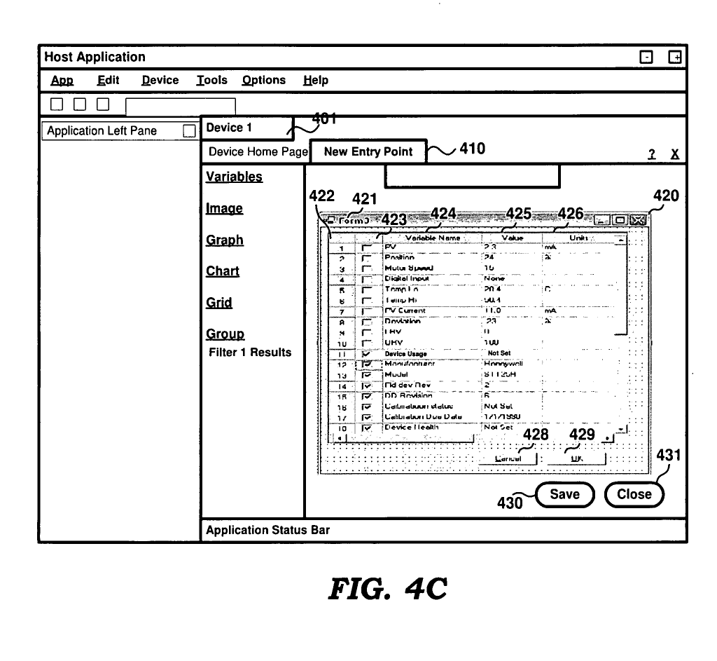

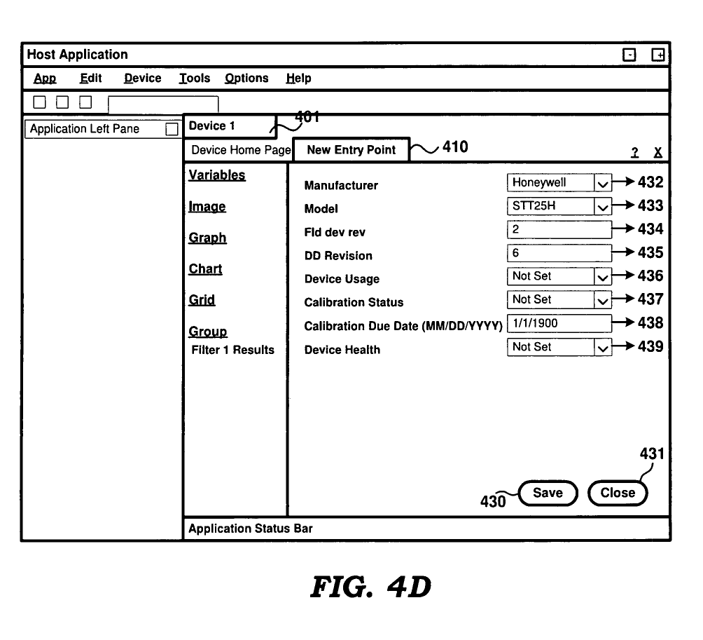

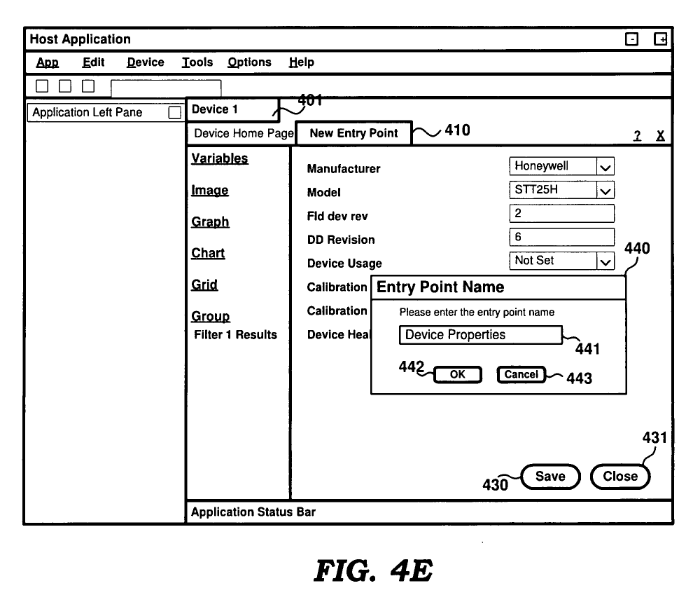

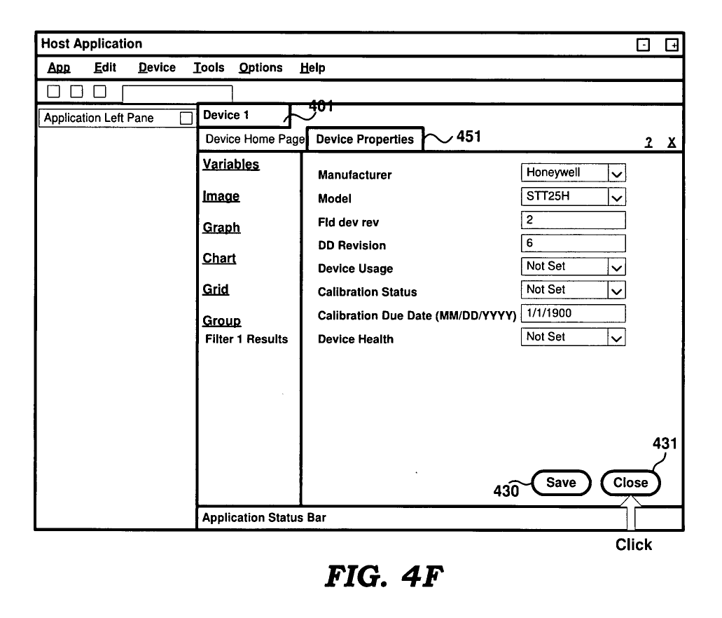

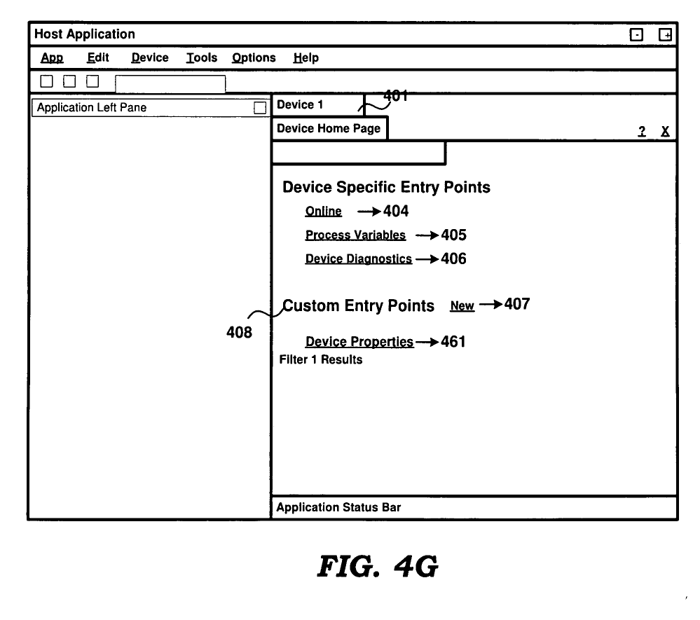

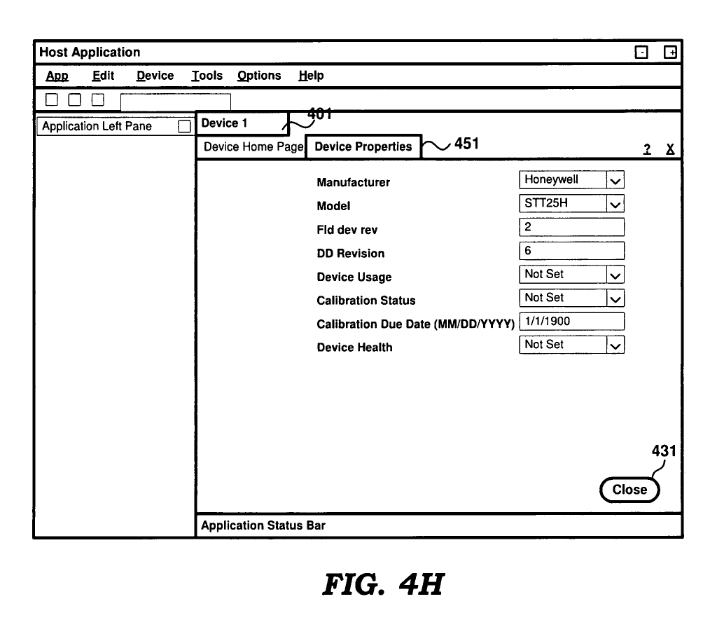

In step 210, server 160 enables an administrator to specify a first set of entry points for a field device. In an embodiment, the administrator may be provided with a suitable graphical user interface such as a menu and user input fields presented on client systems (operator stations 110-1 to 110-4) to specify the entry points (user entry points). Examples of the manner in which a administrator may specify the entry points, are described below with respect to FIG. 4. However, other approaches, such as those based on plain editors, which enable the administrators to enter text to specify the entry points, can also be implemented without departing from the scope and spirit of several aspects of the present invention, as will be apparent to one skilled in the relevant arts by reading the disclosure provided herein.

In step 220, server 160 receives a command from a user to manage the field device. The command may be received from the client systems (or any management station, including server 130, in general), which may provide appropriate user interfaces to the user to issue commands to manage field devices 190-1 to 190-3, and also to display the responses. In general, the user selects the field devices and in combination indicates a request to manage the field device to start managing the field device from the corresponding management station.

In step 230, server 160 determines a second set of entry points according to a device description of the field device. Server 160 may examine the DD to retrieve the entry points (DD entry points) provided by the device manufacturer in the DD. As noted above, the DD entry points may be specified by a manufacturer of the device.

In step 240, server 160 includes both of the first set of entry points and the second set of entry points in a page displayed to the user for the entry points. The entry points may be displayed on a page of a user interface presented to the user on client systems (from where the user sent a command in step 220) in response to the command received from a user to manage the field device, in step 220. The flow chart ends in step 299.

By enabling an administrator to specify a set of entry points, which may be provided to a user, an aspect of the present invention provides convenient entry points for users in the management of field devices. According to another aspect of the present invention, a vendor of the management software may specify a set of entry points (in addition to the entry points in the DD), which may be provided as convenient entry points for users in the management of field devices, as described below.

### 4. Vendors Providing Convenient Entry Points

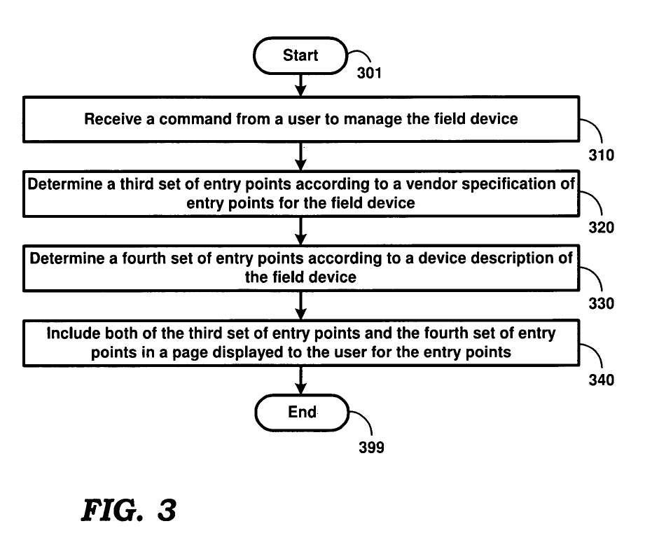

FIG. 3 is a flowchart illustrating the manner in which convenient entry points may be provided for users, in the management of field devices according to another embodiment of the present invention. The flowchart is described with respect to FIGS. 1 and 2 merely for illustration. However, various features can be implemented in other environments and other components/blocks without departing from several aspects of the present invention. Furthermore, the steps are described in a specific sequence merely for illustration.

Alternative embodiments in other environments, using other components and different sequence of steps can also be implemented without departing from the scope and spirit of several aspects of the present invention, as will be apparent to one skilled in the relevant arts by reading the disclosure provided herein. The flowchart starts in step 301, in which control passes immediately to step 310.

In step 310, server 160 receives a command from a user to manage a field device, and can be performed similar to step 210 noted above.

In step 320, server 160 determines a third set of entry points according to a vendor specification of entry points for the field device. The vendor may specify entry points (vendor entry points) that may be convenient to the target group of users and store the information about these entry points, for example in database 140. Server 160 may access the stored information to determine the vendor entry points (third set of entry points).

In step 330, server 160 determines a fourth set of entry points according to a device description of the field device. Server 160 may determine the fourth set of entry points as described in step 230 with reference to FIG. 2.

In step 340, server 160 includes both of the third set of entry points and the fourth set of entry points in a page displayed to the user for the entry points, as described in step 240. The flow chart ends in step 399.

By enabling vendors and administrators to specify corresponding sets of entry points, which may be provided to users, an aspect of the present invention provides convenient entry points for users in the management of field devices.

Various types of user interfaces may be provided consistent with the flowcharts described above. The description is continued with respect to example embodiments in which administrators specify desired custom/desired entry points.

### 5. Example User Experience

FIGS. 4A-4H depict the manner in which convenient (custom) entry points may be specified, according to an aspect of the present invention. Each of the figures represent a display/image screen at a corresponding time instant, presented on a client system such as operator stations 110-1 to 110-4. These images are representative snapshots in a sequence of successive images, as will be apparent from the description below.

FIG. 4A represents a home page (Device Home Page) opened when a user selects a corresponding device for management. The home page represents the first page displayed when a corresponding device is selected (for management). The name of the device is shown at 401, and may correspond to field device 190-1.

In FIG. 4A, the user is presented with a user interface showing three entry points “Online” 404, “Process Variables” 405 and “Device Diagnostics” 406 under the label “Device Specific Entry Points” 403. Entry points 404-406 represent the entry points specified according to the DD of device 190-1, as noted in sections above.

The user is shown to have chosen “Create Entry Point” 402 on the menu, resulting in a selection “New” 407 being displayed against label “Custom Entry Points” 408. A user may click “New” 407 to create a new custom entry point.

FIG. 4B represents a screen presented to a user after the user has clicked “New” 407. The screen is shown containing labels Variables 411, Image 412, Graph 413, Char t 414, Grid 415, and Group 416, under label New Entry Point 410 as the title, providing links to items that are defined in the DD. For example, Variables 411 provides a link to all the variables (or at least the specific variables based on which custom entry points can be specified) defined in the DD for Device 1. A user may click on the label(s) (of the links) 411-416 to view/access a page listing the corresponding items and choose the items to be included in the custom entry point.

FIG. 4C depicts the screen after the user has clicked on Variables,411 of FIG. 4B. The screen is shown containing a table 420 containing multiple rows and multiple columns with each row depicting a serial number 422, variable name 424, value 425, and units 426 for the variables defined in the DD for Device 1. Each row also has a selection area 423 in which a user may click to include the corresponding variable in the custom entry point (indicated by a tick mark in the selection area 423 for the selected item).

An administrator may also click in the selection area of a variable which has been already selected (indicated by the tick mark in the selection area 423) to de-select the variable (indicated by absence of the tick mark in the selection area 423). The variables with serial numbers 11 to 18 are shown as having been selected by the user to be included in the custom entry point. A user may cancel 428 the selections and return to the screen depicted by FIG. 4B or click OK 429 to accept the selections.

FIG. 4D shows the screen on clicking OK 429 of FIG. 4C. The items (variables) that were selected in FIG. 4C are listed, as shown in fields 433-439. A user may also save 430 the selection or close 431 the display (to return to the device home page).

FIG. 4E shows the screen after the user clicks save 430 of FIG. 4D. The user is presented a dialogue box 440 with a field 441 to enter a name for the custom entry point. A user may enter a name and save the new entry point by clicking OK 442 or cancel 443 the save action. In FIG. 4E, the user is shown having entered“Device Properties” as the name for the custom entry point, in field 441.

FIG. 4F represent a screen after the user has clicked OK 442 of FIG. 4E. The label New Entry Point 410 of FIGS. 4B-4E is changed to Device Properties 451 (entered by the user in field 441 of FIG. 4E).

FIG. 4G shows the screen (home page) after the user has clicked close 431 of FIG. 4F. A new label Device Properties 461, representing a custom entry point created by a user, as described above, may be observed under Custom Entry Points 408. It should be appreciated that the screen of FIG. 4G would be displayed as a home page when the user selects device 190-1 for management.

A user may click on DD provided entry points 404-406 or custom entry point Device Properties 461 to access the corresponding entry points.

FIG. 4H shows the screen when a user accesses the custom entry point Device Properties 461 of FIG. 4G. The user is presented with all the items that were selected for inclusion while creating the custom entry point (as described above) and the corresponding information (retrieved from field device 190-1).

It should be appreciated that the example custom entry of above is shown with respect to monitoring the status of some variables of interest, merely for illustration. However, the custom entry points may provide easy access to other types of information (or in other forms) as well.

For example, clicking on graph 413 of FIG. 4B may enable the administrator to select specific variables for which graphs are desirable. Links to each of these graphs may also be provided as additional entries (e.g., below device properties 461 of FIG. 4G) when a home page is thereafter opened. The historic values of the variable for a graph may be retrieved from database 140 and displayed upon selection of the corresponding link.

Similarly, the administrator may define custom entry points to display real-time data (retrieving each data point from the corresponding field device) using the Charts 414 option of FIG. 4B.

It should be appreciated that a vendor of the management software may also use the interfaces of above to provide the additional custom entry points. However, given that the vendors generally have more expertise, more complex approaches can be employed as well (for example, by editing the file representing the custom entry points 530, described below).

Thus by using a user interface as described above, a user may create custom entry points and thereafter use such entry points to view the related information. The interfaces and features described above may be implemented using various software architectures. The description is continued with respect to an example software architecture using which the interfaces/features of above may be implemented.

### 6. Software Architecture

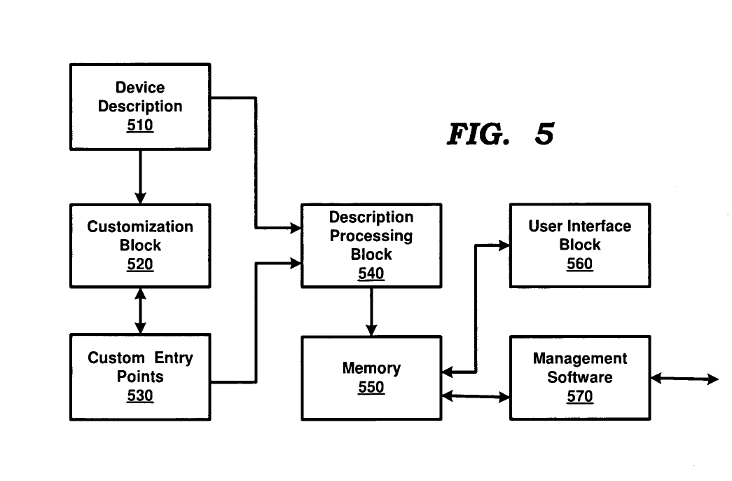

FIG. 5 is a block diagram of a digital processing system (server 160) which may provide custom entry points to users according an aspect of the present invention. The block diagram there is shown containing device description file 510, customization block 520, custom entry points 530, description processing block 540, memory 550, user interface block 560 and management software 570. Each block is described below in detail.

The block diagram is shown containing only representative systems for illustration. However, real-world environments may contain more/fewer/different systems/components/blocks, both in number and type, depending on the purpose for which the environment is designed, as will be apparent to one skilled in the relevant arts.

Device description data 510 contains the device description (DD) related to each of the devices sought to be managed. In an embodiment, the device description is stored in a convenient format (e.g., XML) after appropriate pre-processing (potentially external to server 160). In general, each format has a syntax and semantics, at a conceptual level easy for parsing by the machine and/or for human readability. Device description 510 may be stored locally (for example in a database such as database 140) or provided from a removable storage device such as flash memory or made available online through a communication link, etc.

Custom entry points 530 stores data representing the various entry points specified by an administrator, as described above with respect to FIGS. 4A-4H. The data may also be stored in the same format as in which device description 510 is stored, thereby simplifying the task of description processing block 540. Custom entry points 530 may also include the entry points specified by vendor, as described above with respect to FIG. 3.

In an embodiment, all the entry points are stored in the form of XML data in a single file and read into the random access memory (RAM) during execution. Appendix A contains the DD specified entry points 404/405/406 (assuming that the vendors or users have not yet specified the entry points), and Appendix B contains both the DD specified entry points and custom entry points (of FIG. 4G) added by the vendor/user. Appendix B further shows the various other inputs (of FIGS. 4E/4F) provided during the definition of the custom entry points. The structure for the DD specified entry points is not included in the two appendices as being apparent to one skilled in the relevant arts.

It should be appreciated that custom entry points related to several devices may be stored in custom entry points data 530, though the description is previous sections is provided substantially with respect to a single field device. The data representing custom entry points 530 and device description 510 may be stored and retrieved, for example, in database 140.

Customization block 520 represents a block which enables an administrator to specify custom entry points, as described above with respect to FIGS. 4A-4H. Customization block provides the interface for creating custom entry points and then stores data representing each custom entry point in the appropriate format, compatible with the specifications for the device description 510.

For example, in response to an administrator clicking on New 407, customization block 520 presents (sends to operator stations) the screens of FIGS. 4B-4E, receives inputs from the administrator and stores (in 530) the information pertaining to the custom entry point created, when the administrator presses OK 442 of FIG. 4E.

Description processing block 540 retrieves device description data 510 and custom entry points 530, and stores the combined data in appropriate templates provided in memory 550. The templates may contain the pertinent information, lending to easy retrieval, as the user navigate through various menus. The retrieval and storing may be performed in response to request from management software 570. The data thus stored in templates may indicate that the combined information of entry points (from both 510 and 530) is to be included in a home page.

Memory 550 may be implemented as a random access memory, and store the various templates described above. The information may include the entry points determined by description processing block 540. Other blocks such as user interface block 560 and management software 570 may retrieve the stored information from memory 550.

User interface block 560 provides a user interface for displaying information (such as a device home page described above with respect to FIG. 4A) to a user as well as receiving inputs (such as user selection of an entry point) from a user. The information may be displayed on and inputs received through operator stations 110-1 to 110-4. The templates stored in memory may be used while the user navigates thru various parts of the information (e.g., menus specified by device description).

Management software 570 represents an application executing in server 160 and enables a user to manage field devices from client systems such as operator stations 110-1 to 110-4. A user may access the device home page for a field device (such as field device 190-1) through management software 570. In general, the various inputs provided by the user at the management station are received, translated to corresponding commands if the response requires interfacing with a field device, and sent to the field device in the form of commands. The response from the field device is sent back to the field device sending the request.

Similarly, when historical information is to be sent to a client system (in response to receiving a user request from the operator station), the information may be retrieved from the database and sent to the operator station. In general, various management operations described with respect to FIG. 1 may be executed by management software.

It should be appreciated that the various features described above can be implemented in various embodiments as a desired combination of one or more of hardware, software and firmware. The description is continued with respect to an embodiment in which various features are operative when software instructions are executed.

### 7. Digital Processing System Architecture

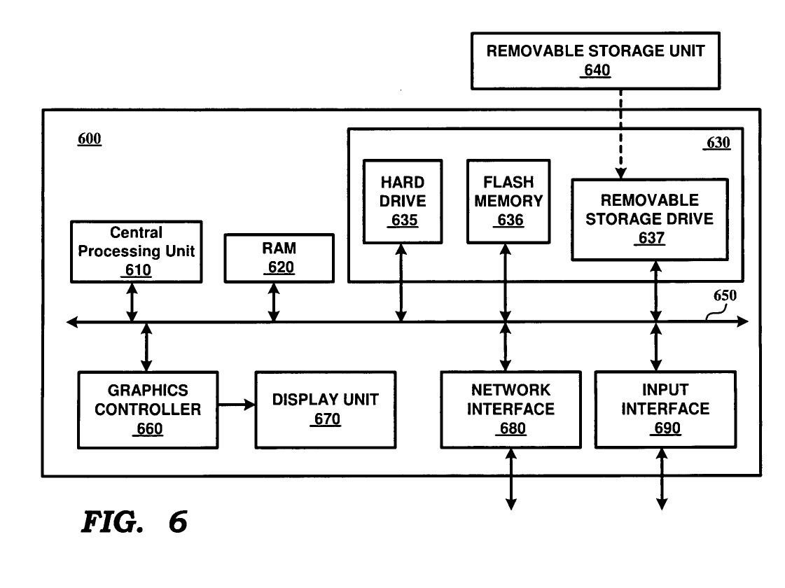

FIG. 6 is a block diagram illustrating the details of digital processing system 600 in which various aspects of the present invention are operative by execution of appropriate software instructions. System 600 may correspond to one of server 160 and/or operator stations 110-1 through 110-4, providing various features described above. Digital processing system 600 may contain one or more processors such as central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present invention. CPU 610 may contain multiple processing units, with each processing unit potentially being designed for a specific task. Alternatively, CPU 610 may contain only a single general purpose, processing unit. RAM 620 may receive instructions from secondary memory 630 using communication path 650. RAM 620 may also be used to store the data described with respect to memory 550.

Graphics controller 660 generates display signals (e.g., in RGB format) to display unit 670 based on data/instructions received from CPU 610. Display unit 670 contains a display screen (on which the screens of FIGS. 4A-4H may be displayed) to display the images defined by the display signals. Input interface 690 may correspond to a key-board and/or mouse (using which the inputs described with respect to FIGS. 4A-4H and also the user interactions at operator stations are provided). Network interface 680 provides connectivity to a network (e.g., using Internet Protocol), and may be used to communicate with the other systems of FIG. 1.

Secondary memory 630 may contain hard drive 635, flash memory 636, and removable storage drive 637. Secondary memory 630 may store the data and software instructions, which enable digital processing system 600 to provide several features in accordance with the present invention. Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable storage medium having stored therein computer software and/or data.

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present invention described above.

### 8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system.

1. A method of providing convenient entry points in the management of field devices in a process control plant, said method comprising:
enabling an administrator to specify a first set of entry points for a field device;
receiving a request from a user to manage said field device;
determining a second set of entry points for said field device according to a Device Description (DD) for said field device; and
presenting said first set of entry points and said second set of entry points to said user as entry points in a home page in response to receiving said request.

2. The method of claim 1, further comprising:
determining a third set of entry points provided by a vendor,
wherein said third set of entry point are also included in said home page.

3. The method of claim 1, wherein both of said DD and said first set of entry points are received in a common format.

4. The method of claim 1, wherein said enabling comprises:
sending for display a first screen containing a first field, which when selected by said administrator causes a second screen to be displayed, wherein said second screen enables said administrator to specify a desired information as a first entry point contained in said first set of entry points.

5. The method of claim 4, wherein said first field indicates that a variable defined by said DD can be monitored based on said first entry point, said enabling further comprises:
displaying a set of variables specified by said DD in said second display screen;
receiving a selection of a variable in said set of variables;
storing data indicating that said variable is sought to be monitored when said user selects said first entry point.

6. The method of claim 5, further comprising:
receiving data indicating that said first entry point is selected by said user;
retrieving a value corresponding to said variable of said field device in response to selection of said first entry point; and
sending said value for display to said user.

7. The method of claim 6, wherein said first entry point is specified by said administrator as one of variables, graph and chart, said method further comprising:
displaying said value as a part of a graph if said administrator had specified said first entry point as said graph, wherein said value is a historical value stored in a database;
displaying said value as a part of a chart if said administrator had specified said first entry point as said chart, wherein said value is a real-time value retrieved from said field device; and displaying said value as a value of a field if said administrator had specified said first entry point as said variable.

8. A computer readable medium storing one or more instructions enabling a system to provide convenient entry points in the management of field devices in a process control plant, wherein execution of said one or more sequences of instructions by one or more processors contained in said synchronization unit causes said system to perform the actions of:
enabling an administrator to specify a first set of entry points for a field device;
receiving a request from a user to manage said field device;
determining a second set of entry points for said field device according to a Device Description (DD) for said field device; and
presenting said first set of entry points and said second set of entry points to said user as entry points in a home page in response to receiving said request.

9. The computer readable medium of claim 8, further comprising:
determining a third set of entry points provided by a vendor,
wherein said third set of entry point are also included in said home page.

10. The computer readable medium of claim 8, wherein both of said DD and said first set of entry points are received in a common format.

11. The computer readable medium of claim 8, wherein said enabling comprises:
sending for display a first screen containing a first field, which when selected by said administrator causes a second screen to be displayed, wherein said second screen enables said administrator to specify a desired information as a first entry point contained in said first set of entry points.

12. The computer readable medium of claim 11, wherein said first field indicates that a variable defined by said DD can be monitored based on said first entry point, said enabling further comprises:
displaying a set of variables specified by said DD in said second display screen;
receiving a selection of a variable in said set of variables;
storing data indicating that said variable is sought to be monitored when said user selects said first entry point.

13. The computer readable medium of claim 12, further comprising:
receiving data indicating that said first entry point is selected by said user;
retrieving a value corresponding to said variable of said field device in response to selection of said first entry point; and
sending said value for display to said user.

14. The computer readable medium of claim 13, wherein said first entry point is specified by said administrator as one of variables, graph and chart, further comprising one or more instructions for:
displaying said value as a part of a graph if said administrator had specified said first entry point as said graph, wherein said value is a historical value stored in a database;
displaying said value as a part of a chart if said administrator had specified said first entry point as said chart, wherein said value is a real-time value retrieved from said field device; and displaying said value as a value of a field if said administrator had specified said first entry point as said variable.

15. A system for providing convenient entry points in the management of field devices in a process control plant, said system comprising:
means for enabling an administrator to specify a first set of entry points for a field device;
means for receiving a request from a user to manage said field device;
means for determining a second set of entry points for said field device according to a Device Description (DD) for said field device; and
means for presenting said first set of entry points and said second set of entry points to said user as entry points in a home page in response to receiving said request.

16. The system of claim 15, further comprising:
means for determining a third set of entry points provided by a vendor,
wherein said third set of entry point are also included in said home page.

17. The system of claim 15, wherein both of said DD and said first set of entry points are received in a common format.

18. The system of claim 15, wherein said means for enabling is operable to:
send for display a first screen containing a first field, which when selected by said administrator causes a second screen to be displayed, wherein said second screen enables said administrator to specify a desired information as a first entry point contained in said first set of entry points.
